(19) United States
(12) Patent Application Publication
(10) Pub. No.: US 2026/0200809 A1
(43) Pub. Date: Jul. 16, 2026

(54) A MIX DESIGN METHOD FOR ALKALI ACTIVATED CONCRETE

(71) Applicant: UNIVERSITEIT GENT, Gent (BE)

(72) Inventors: Beibei SUN, Guangdong (CN); Yubo SUN, Merelbeke (BE); Guang YE, Den Haag (NL); Geert DE SCHUTTER, Gent (BE)

(21) Appl. No.: 19/131,801

(22) PCT Filed: Nov. 22, 2023
(86) PCT No.: PCT/EP2023/082678

§ 371 Date: May 21, 2025

(30) Foreign Application Priority Data
Nov. 23, 2022 (EP) 22208970.8

(51) Int. Cl. C04B 40/00; C04B 22/06; C04B 28/24

(52) U.S. Cl. CPC C04B 40/0032; C04B 22/062; C04B 28/24; C04B 40/0039; C04B 2201/50

(57) ABSTRACT

A method is provided for determining a mix proportion of an alkali activated concrete, AAC, mixture for a set of desired physical properties of the AAC, and for a dry bulk volume of one or more coarse aggregates and a fine aggregate per unit volume of AAC. The method includes determining (202) a mix proportion of an alkali activated paste, AAP, mixture from the set of desired physical properties of the AAC based on a predetermined relationship (210) between the set of desired physical properties of the AAC and the mix proportion of the AAP mixture. The AAP mixture has one or more precursors, one or more chemical compounds of an alkali activator, and water according to the determined mix proportion of the AAP. The method further includes determining (203) masses (261, 262) of the respective one or more coarse aggregates per unit volume of AAC and a mass (263) of the fine aggregate per unit volume of AAC by packing (230, 240, 250) particles of the respective aggregates (231, 241, 251) within the dry bulk volume (234) according to a particle packing model. The method further includes determining (204) a mass of the AAP mixture per unit volume of AAC to complete a remaining volume within the unit volume.

### FIELD OF THE INVENTION

The present invention generally relates to designing alkali-activated concrete mix proportions.

### BACKGROUND OF THE INVENTION

Alkali-activated concrete, AAC, is an environmental friendly alternative to traditional concrete, e.g. Portland cement concrete, which typically requires substantial amounts of natural resources and emits substantial amounts of carbon dioxide during its production process. AAC typically comprises one or more precursors rich in alumina and/or silica, an alkaline activator to initiate the setting and hardening reactions, one or more aggregates, and water. The precursors are typically industrial by-products, e.g. fly ash and blast furnace slag, further contributing to the ecological and economical appeal of AAC.

The ratio of the constituents in AAC, i.e. the mix proportion, determine the mechanical properties and durability of the cured concrete structure. As such, the mix proportion should be determined or designed according to the desired application or function of the concrete structure.

Typically, a plurality of empirical mixing proportions are proposed, produced, cured, and tested to identify a mixture that approximates the required properties in a trial-and-error manner, as it remains a problem to predict the mechanical properties of an AAC mixture. It is a further problem that this design process is time and labour intensive, as the curing time of the mixtures is long and a plurality of mixtures are evaluated. Additionally, the proposed mix proportions typically need to be adjusted to achieve the desired mechanical properties. This has the further problem that adjusting the mixture does not guarantee that the desired mechanical properties are obtained, as the understanding of the effects of different design factors on the physical properties of AAC is limited.

### SUMMARY OF THE INVENTION

It is an object of the present invention, amongst others, to solve or alleviate the above identified problems and challenges by providing a mix design method for an alkali-activated concrete, AAC, mixture.

According to a first aspect, this object is achieved by a method for determining a mix proportion of an alkali activated concrete, AAC, mixture for a set of desired physical properties of the AAC, and for a dry bulk volume of one or more coarse aggregates and a fine aggregate per unit volume of AAC. The desired physical properties include a desired workability, a desired compressive strength, and a desired setting time of the AAC. The AAC mixture comprises one or more precursors, an alkali activator comprising one or more chemical compounds, the one or more coarse aggregates, the fine aggregate, and water. The method comprises:
determining a mix proportion of an alkali activated paste, AAP, mixture from the set of desired physical properties of the AAC based on a predetermined relationship between the set of desired physical properties of the AAC and the mix proportion of the AAP mixture; wherein the AAP mixture comprises the one or more precursors, the one or more chemical compounds of the alkali activator, and water according to the determined mix proportion of the AAP;
determining masses of the respective one or more coarse aggregates per unit volume of AAC and a mass of the fine aggregate per unit volume of AAC by packing particles of the respective aggregates within the dry bulk volume according to a particle packing model; and
determining a mass of the AAP mixture per unit volume of AAC to complete a remaining volume within the unit volume.

The dry bulk volume is thus a portion of a unit volume of AAC, e.g. a portion of one cubic meter of AAC, that includes one or more coarse aggregates and a fine aggregate. The aggregates may be substantially inert granular materials such as, for example, sand, gravel, or crushed stone. The fine aggregate is the aggregate within the dry bulk volume that is characterized by the finest particles, i.e. smallest particle size. The dry bulk volume may be determined based on characteristics of the used aggregates, e.g. based on a predetermined relationship between the dry bulk volume, a maximum particle size of the one or more coarse aggregates, and a mean particle size of the fine aggregate.

Packing the particles of the one or more coarse aggregates and the fine aggregate within the dry bulk volume according to a particle packing model allows determining the volume occupied by the respective aggregate particles within the dry bulk volume, thereby allowing to determine the masses of the respective aggregates per unit volume of AAC. Determining the masses of the respective aggregates may further be based on respective characteristics of the used aggregates, e.g. respective void ratios and particle densities. This allows determining a mix proportion of an AAC mixture with desired physical properties for any combination of aggregates, i.e. regardless of the used aggregates. Packing the particles may refer to identifying a dense arrangement of particles within a predetermined volume. The particle packing model may, for example, be a binary packing model, a ternary packing model, a multimodal packing model, a continuous packing model, or a close-packing model.

The remaining volume within the unit volume is completed by the AAP mixture. The remaining volume may be the unit volume reduced by the dry bulk volume and/or reduced by a volume of voids between the particles of aggregates within the dry bulk volume. The AAP mixture is a cementitious material that comprises one or more precursors and an alkali activator. The one or more precursors may be industrial by-products and may be rich in alumina and/or silica such as, for example, fly ash and blast furnace slag. The alkali activator comprises one or more chemical compounds, e.g. sodium hydroxide, sodium silicate, and water. The alkali activator enables the one or more precursors to react, thereby initiating the setting and hardening reactions of the AAC.

The AAP mixture is characterized by a mix proportion indicative of the ratio of constituents in the AAP mixture in terms of weight, e.g. ratios of one or more precursors and/or one or more chemical compounds. A predetermined relationship between the set of physical properties of AAC and the mix proportion of an AAP mixture allows determining the mix proportion of the AAP mixture such that the AAC meets the set of desired physical properties. Thus, the predetermined relationship relates compressive strength, workability, and setting time to the ratio of constituents in the AAP mixture in terms of weight. The predetermined relationship may, for example, be expressed as a multi-dimensional look-up table that relates physical properties of AAC to ratios of constituents in the AAP mixture. This predetermined relationship allows determining the mix proportion of the AAP mixture accurately and fast, as the mix proportion of the AAP mixture can directly be obtained from the predetermined relationship.

By the determined mix proportion of the AAP mixture and the remaining volume within the unit volume, the mass of the constituents of the AAP mixture can be determined, i.e. the one or more precursors, the one or more chemical compounds, and water. In doing so, the masses of the respective constituents of the AAC mixture are determined per unit volume of AAC for a set of desired physical properties of the AAC, i.e. for a desired application. This allows determining the mix proportion of an AAC mixture in a cost-efficient manner, i.e. with limited trial and error. This has the advantage that the time and labour to determine or design an AAC mixture can be reduced; as the curing, testing, and screening of multiple empirical mixing proportions can be avoided. It is a further advantage that the method can easily be incorporated into existing production methods of conventional concrete. It is a further advantage that this can improve the utilization of AAC as a more ecological alternative to traditional concrete.

According to an embodiment, determining masses of the respective one or more coarse aggregates per unit volume of AAC may further be based on particle densities of the respective one or more coarse aggregates, and void ratios of the respective one or more coarse aggregates.

The void ratio of an aggregate may be indicative of the ratio of the volume of voids to the volume of aggregate particles, i.e. solids. The particle density of an aggregate may be indicative of the ratio of the mass of an aggregate particle to the volume of the particle. The particle densities and the void ratios of the respective one or more coarse aggregates may be obtained by characterizing the coarse aggregates, or may be provided by a supplier.

According to an embodiment, determining a mass of the fine aggregate per unit volume of AAC may further be based on a particle density of the fine aggregate, the void ratios of the respective one or more coarse aggregates, and an aggregate ratio; wherein the aggregate ratio is indicative for a ratio of the volume of fine aggregate to a combined volume of the one or more coarse aggregates.

The aggregate ratio allows adjusting the workability of the AAC mixture as a higher quantity of fine aggregate, associated with an increased aggregate ratio, results in higher cohesion and lower slump value of the AAC mixture.

According to an embodiment, the method may further comprise determining the aggregate ratio based on a predetermined relationship between the aggregate ratio, the maximum particle size of the one or more coarse aggregates, and a maximum particle size of the fine aggregate, e.g. according to the NBN EN 206 standard.

According to an embodiment, the alkali activator may comprise an aqueous solution of a first chemical compound and a second chemical compound; and the AAP mixture may comprise a first precursor, a second precursor, and the alkali activator.

For example, the first chemical compound may be sodium oxide, the second chemical compound may be silica, the first precursor may be blast furnace slag, BFS, and the second precursor may be fly ash, FA.

According to an embodiment, the AAP mixture may be characterized by a weight ratio of water to the first and second precursor, a weight ratio of the first precursor to the first and second precursor, a weight ratio of the first chemical compound to the first and second precursor, and a weight ratio of the second chemical compound to the first chemical compound; and wherein determining the mix proportion of the AAP mixture further comprises determining the respective weight ratios.

According to an embodiment, determining a mass of the AAP mixture per unit volume of AAC may further comprise determining a mass of the respective precursors, a mass of the respective chemical compounds of the alkali activator, and a mass of water based on the weight ratios.

In other words, the respective weight ratios may be determined from the predetermined relationship between the set of desired physical properties of the AAC and the mix proportion of the AAP. These determined weight ratios may further allow determining the masses of the respective one or more precursors and one or more chemical compounds in the alkali activator. These masses, in turn, allow producing an AAP mixture that yields AAC that meets the desired physical properties.

According to an embodiment, the method may further comprise determining the dry bulk volume based on a predetermined relationship between the dry bulk volume, a maximum particle size of the one or more coarse aggregates, and a mean particle size of the fine aggregate.

According to an embodiment, the method may further comprise determining a maximum particle size of the one or more coarse aggregates based on a minimum spacing of a formwork for holding the AAC mixture until set and hardened into an AAC structure, a thickness of the AAC structure, and/or a minimum spacing of reinforcements in the AAC structure.

According to an embodiment, the method may further comprise selecting the one or more precursors based on a set of minimum conditions for material properties of the respective precursors; and selecting the one or more coarse aggregates based on a maximum particle size of the one or more coarse aggregates.

According to an embodiment, the method may further comprise:
producing the AAC mixture according to the determined mix proportion of the AAC mixture;
testing a fresh sample of the AAC mixture to obtain a slump value and/or testing a hardened sample of the AAC mixture to obtain a compressive strength value; and
adjusting the determined mix proportion of the AAC mixture if the slump value and/or the compressive strength value deviate from the desired physical properties of the AAC.

Producing the AAC mixture may comprise combining and mixing the one or more coarse aggregates, the fine aggregate, the AAP mixture according to the determined mix proportion of the AAP, and water, according to the determined mix proportion for the AAC mixture. In other words, combining the constituents of the AAC mixture according to the determined masses for the respective constituents per unit volume of AAC.

The slump value may be indicative of the workability of the AAC mixture. The slump value may be obtained by performing a slump test, wherein a freshly produced AAC mixture is poured into a slump cone and the height difference is measured before and after removing the slump cone. Alternatively, the slump value may be obtained by a flow table test, a K-slump test, a British compacting factor test, a Vebe consistometer test, or by means of an automated slump meter. The compressive strength value may, for example, be obtained by breaking an AAC sample in a compression-testing machine, typically after setting and hardening for 7, 28, or 90 days.

Adjusting the determined mix proportion of the AAC mixture may include iterating one or more steps for determining a mix proportion of an AAC mixture. This further allows optimizing the mix proportion of the AAC mixture such that the AAC meets the set of desired physical properties. Adjusting the AAC mixture if the slump value deviates from the desired workability may be performed before testing the compressive strength value, i.e. without waiting for the fresh sample to harden. This has the further advantage that the adjusting can be more efficient, as a futile setting period before testing the compressive strength can be avoided. Alternatively, the compressive strength value may be tested even if the slump value deviates from the desired workability.

According to an embodiment, adjusting the determined mix proportion of the AAC mixture may further comprise adjusting the determined mix proportion according to a predetermined relationship between the mix proportion of the AAC mixture and the slump value.

This allows adjusting the determined mix proportion in a quantitative and controlled manner which predicts the effect of changing the mix proportion on the workability of the AAC. This further allows producing and testing a limited number of AAC mix proportions, as the change in the workability of the AAC can be estimated in advance. This has the advantage that an AAC mixture that meets the desired physical properties can be determined in a cost-efficient and time-efficient manner.

According to an embodiment, adjusting the determined mix proportion may further comprise adjusting the mass of water per unit volume of AAC according to a predetermined positive linear relationship between the mass of water per unit volume of AAC and the slump value of the AAC mixture.

The slope of the predetermined positive linear relationship may be characterized by a change of at least about 1.8 mm and at most about 3.6 mm in the slump value of the AAC mixture for a change of about 1 kg/m³ in the mass of water per unit volume of AAC, preferably by a change of about 2.7 mm in the slump value of the AAC mixture for a change of about 1 kg/m³ in the mass of water per unit volume of AAC.

According to an embodiment, adjusting the determined mix proportion may further comprise adjusting the weight ratio of water to the first and second precursor in the AAP mixture according to a predetermined positive linear relationship between the weight ratio of water to the first and second precursor in the AAP mixture and the slump value of the AAC mixture.

The slope of the predetermined positive linear relationship may be characterized by a change of at least about 1 mm and at most about 11 mm in the slump value of the AAC mixture for a change of about 0.01 in the weight ratio of water to the first and second precursor, preferably by a change of about 6 mm in the slump value of the AAC mixture for a change of about 0.01 in the weight ratio of water to the first and second precursor. In addition to changing the slump value, adjusting the weight ratio of water to the first and second precursor may also change the compressive strength value, e.g. by around 0.8 MPa for a change of about 0.01 in the weight ratio of water to the first and second precursor.

According to an embodiment, adjusting the determined mix proportion may comprise at least one of:
adjusting a ratio of the volume of fine aggregate to a combined volume of the one or more coarse aggregates to adjust the cohesion and water retention of the AAC mixture;
selecting at least one different coarse aggregate characterized by a different maximum particle size and/or different shaped particles;
adding or removing an amount of admixture; and
determining a different mix proportion of the AAP mixture with a different weight ratio of the first precursor to the first and second precursor.

The slump value of the AAC mixture may thus be increased by increasing the mass of water per unit volume of AAC, adding an amount of admixture, increasing the maximum particle size of at least one coarse aggregate, and lowering the weight ratio of the first precursor to the first and second precursor in the mix proportion of the AAP mixture, and vice-versa.

According to an embodiment, adjusting the determined mix proportion of the AAC mixture may further comprise adjusting the determined mix proportion according to a predetermined relationship between the mix proportion of the AAC mixture and the compressive strength value.

This allows adjusting the determined mix proportion in a quantitative and controlled manner which predicts the effect of changing the mix proportion on the compressive strength of the AAC. This further allows producing and testing a limited number of AAC mix proportions, as the change in the compressive strength of the AAC can be estimated in advance. This has the advantage that an AAC mixture that meets the desired physical properties can be determined in a cost-efficient and time-efficient manner.

According to an embodiment, adjusting the determined mix proportion may comprise adjusting the weight ratio of the first precursor to the first and second precursor according to a predetermined positive linear relationship between the weight ratio of the first precursor to the first and second precursor, and the compressive strength value of the AAC mixture.

The slope of the predetermined positive linear relationship may be characterized by a change of at least about 5.5 MPa and at most about 6.5 MPa in the compressive strength value of the AAC mixture for a change of about 0.1 in the weight ratio of the first precursor to the first and second precursor, preferably by a change of about 6 MPa in the compressive strength value of the AAC mixture for a change of about 0.1 in the weight ratio of the first precursor to the first and second precursor. In addition to changing the compressive strength value, adjusting the weight ratio of the first precursor to the first and second precursor may also change the slump value, e.g. by around 17 mm for a change of about 0.1 in the weight ratio of the first precursor to the first and second precursor.

According to an embodiment, adjusting the determined mix proportion may comprise, if the weight ratio of the second chemical compound to the first chemical compound is lower than a threshold, adjusting the weight ratio of the second chemical compound to the first chemical compound according to a predetermined positive linear relationship between the weight ratio of the second chemical compound to the first chemical compound, and the compressive strength value of the AAC mixture.

The threshold may, for example, be a ratio of about 0.5. The slope of the predetermined positive linear relationship may be characterized by a change of at least about 2.2 MPa and at most about 5.8 MPa in the compressive strength value of the AAC mixture for a change of about 0.1 in the weight ratio of the second chemical compound to the first chemical compound, preferably by a change of about 4 MPa in the compressive strength value of the AAC mixture for a change of about 0.1 in the weight ratio of the second chemical compound to the first chemical compound. In addition to changing the compressive strength value, adjusting the weight ratio of the second chemical compound to the first chemical compound may also change the slump value, e.g. by around 24 mm for a change of about 0.1 in the weight ratio of the second chemical compound to the first chemical compound.

According to an embodiment, adjusting the determined mix proportion may comprise, if the weight ratio of the first chemical compound to the first and second precursor exceeds a threshold, adjusting the weight ratio of the first chemical compound to the first and second precursor according to a predetermined positive linear relationship between the weight ratio of the first chemical compound to the first and second precursor, and the compressive strength value of the AAC mixture.

The threshold may, for example, be a ratio of about 6%. The slope of the predetermined positive linear relationship may be characterized by a change of at least about 3.2 MPa and at most about 6.8 MPa in the compressive strength value of the AAC mixture for about a 1% change in the weight ratio of the first chemical compound to the first and second precursor, preferably by a change of about 5 MPa in the compressive strength value of the AAC mixture for about a 1% change in the weight ratio of the first chemical compound to the first and second precursor. In addition to changing the compressive strength value, adjusting the weight ratio of the first chemical compound to the first and second precursor may also change the slump value, e.g. by around 62 mm for a change of about 1% in the weight ratio of the first chemical compound to the first and second precursor.

### BRIEF DESCRIPTION OF THE DRAWINGS

FIG. 1 shows a typical mix design process for obtaining a mix proportion of an alkali activated concrete, AAC, mixture;

FIG. 2 shows steps according to a method for determining a mix proportion of an AAC mixture for a set of desired physical properties of the AAC;

FIG. 3 shows an example embodiment of a predetermined relationship between a set of physical properties and a mix proportion of an alkali activated paste, AAP, mixture;

FIG. 4 shows additional steps of the method for determining a mix proportion of an AAC mixture, according to embodiments;

FIG. 5A shows an example embodiment of a predetermined positive linear relationship between the mass of water per unit volume of AAC and a 5-min slump value of the AAC mixture;

FIG. 5B shows an example embodiment of a predetermined relationship between the mass of water per unit volume of AAC and a 90-day compressive strength value of the AAC mixture;

FIG. 5C shows an example embodiment of a predetermined positive linear relationship between the weight ratio of water to binder in the AAP mixture per unit volume of AAC and a 5-min slump value of the AAC mixture:

FIG. 5D shows an example embodiment of a predetermined linear relationship between the weight ratio of water to binder in the AAP mixture per unit volume of AAC and a 90-day compressive strength value of the AAC mixture;

FIG. 5E shows an example embodiment of a predetermined positive linear relationship between the weight ratio of a first chemical compound to binder in the AAP mixture per unit volume of AAC and a 5-min slump value of the AAC mixture;

FIG. 5F shows an example embodiment of a predetermined positive linear relationship between the weight ratio of a first chemical compound to binder in the AAP mixture per unit volume of AAC and a 90-day compressive strength value of the AAC mixture;

FIG. 6A shows an example embodiment of a predetermined linear relationship between the weight ratio of a first precursor to binder in the AAP mixture per unit volume of AAC and a 5-min slump value of the AAC mixture;

FIG. 6B shows an example embodiment of a predetermined positive linear relationship between the weight ratio of a first precursor to binder in the AAP mixture per unit volume of AAC and a 90-day compressive strength value of the AAC mixture;

FIG. 6C shows an example embodiment of a predetermined linear relationship between the weight ratio of a second chemical compound to a first chemical compound in the AAP mixture per unit volume of AAC and a 5-min slump value of the AAC mixture; and

FIG. 6D shows an example embodiment of a predetermined linear relationship between the weight ratio of a second chemical compound to a first chemical compound in the AAP mixture per unit volume of AAC and a 90-day compressive strength value of the AAC mixture.

### DETAILED DESCRIPTION OF EMBODIMENT(S)

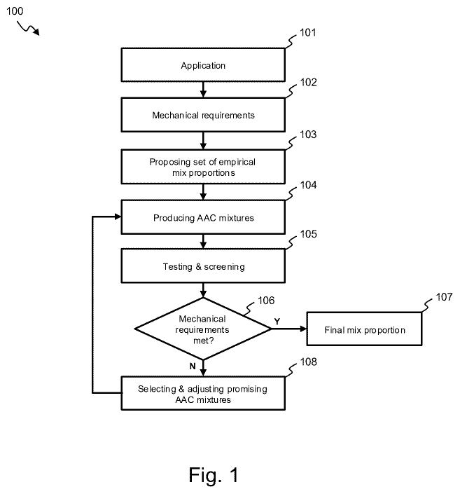

FIG. 1 shows a typical mix design process 100 for obtaining a mix proportion 107 of an alkali activated concrete, AAC, mixture. A mix proportion of an AAC mixture may be indicative of the ratio of constituents in the mixture in terms of volume or weight. Typically, the intended use or function of the hardened AAC, i.e. the application 101, determines the mechanical requirements 102 of the AAC, i.e. the desired physical properties. A set of empirical mix proportions is then typically proposed 103 based on these physical properties. These empirical mix proportions are typically proposed based on a limited set of mix proportions with known mechanical properties, based on limited guidance in literature, based on unreliable rules of thumb, based on expert experience, and/or based on conjecture. Typically, a plurality of empirical mix proportions is proposed in a trial-and-error manner, as it remains a problem to predict the resulting mechanical properties of the AAC.

In a following step 104, the proposed AAC mixtures are produced according to the proposed empirical mix proportions. This may comprise combining and mixing typical constituents of an AAC mixture such as, for example, precursors, an alkali activator, admixture, aggregates, and water. The plurality of AAC mixtures may then be tested and screened in step 105 to determine their respective mechanical properties. This testing is typically time and labour-intensive as the AAC mixtures have to set, harden, and/or cure sufficiently for some tests such as, for example, compression strength testing. As such, completing step 104 and step 105 typically takes between 28 and 90 days to complete.

In the most favourable case, one of the proposed AAC mixtures meets all the mechanical requirements, thereby obtaining the final mix proportion 107 in only one iteration. This mix proportion 107 may then serve as a recipe to produce substantial quantities of AAC mixture for the intended application 101. However, in the more common case, none of the initial proposed AAC mixtures meet all the mechanical requirements. As such, the most promising AAC mixtures may be selected and their respective mix proportions may be adjusted or altered in an attempt to approximate the desired mechanical properties. In other words, the mix proportion of some AAC mixtures may be changed slightly to propose a second generation of empirical AAC mixtures. As predicting the effect of the adjustments of the mix proportion on the resulting mechanical properties of the AAC remains a problem, steps 104, 105, and 106 may be repeated to produce, test, and screen the second generation of empirical AAC mixtures. This iteration may take up to another 90 days to complete, further contributing to the time and labour-intensiveness of designing AAC mixtures. Moreover, redesigning or adjusting the mix proportions does not guarantee that a suitable AAC mix is obtained, as the understanding of the effects of different design factors of the AAC mixture on the mechanical properties of AAC is limited.

As such, the widespread utilization of AAC remains limited even though AAC has promising application prospects as it can be at least equally performant, more ecological than traditional concrete, e.g. Portland cement concrete. It is thus desirable to provide a mix design method for determining a mix proportion of an AAC mixture for desired physical properties of the AAC.

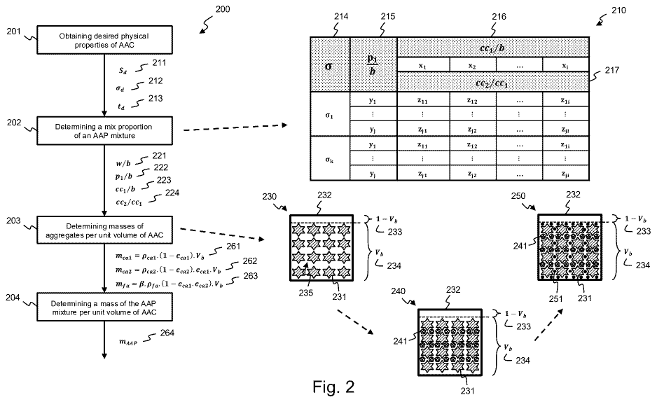

FIG. 2 shows steps 200 according to a method for determining a mix proportion of an AAC mixture for a set of desired physical properties 211, 212, 213 of the AAC. The AAC mixture comprises an alkali activated paste, AAP, one or more coarse aggregates, a fine aggregate. The AAP is a cementitious material that comprises one or more precursors and an alkali activator. The one or more precursors may be industrial by-products rich in alumina and/or silica. The alkali activator enables the one or more precursors to react, thereby initiating the setting and hardening reactions of the AAC mixture, i.e. the solidifying of the AAC mixture.

According to an example embodiment, the AAP mixture comprises a first precursor p₁ and a second precursor p₂; and the alkali activator comprises an aqueous solution of a first chemical compound cc₁ and a second chemical compound cc₂, and water. For example, the first precursor p₁ may be blast furnace slag, BFS, the second precursor p₂ may be fly ash, FA, the first chemical compound cc₁ may be sodium oxide, Na₂O, and the second chemical compound cc₂ may be silica, SiO₂. The alkali activator may, for example, be obtained by mixing sodium hydroxide pearls, sodium silicate solution, and water.

The aggregates in the AAC mixture may be inert granular materials such as, for example, sand, gravel, or crushed stone. The fine aggregate is the aggregate that is characterized by the finest particles, i.e. the smallest particle size. For example, the AAC mixture may comprise a first coarse aggregate characterized by a medium particle size, e.g. between 8 mm and 16 mm, a second coarse aggregate characterized by a small particle size, e.g. between 2 mm and 8 mm, and a fine aggregate characterized by a particle size of between 0.1 mm and 4 mm, e.g. river sand.

The set of desired physical properties includes a desired workability S_{d} 211, a desired compressive strength σ_{d} 212, and a desired setting time t_{d} 213. The desired workability 211 may be indicative of how easily a freshly mixed AAC mixture can be mixed, placed, consolidated, and/or finished with minimal loss of homogeneity. The desired workability 211 may, for example, be expressed as a desired slump value or a desired cohesion value. The desired compressive strength 212 may be indicative of the capacity of the solidified AAC mixture, i.e. AAC, to withstand a compressive load or stress before failure. The desired compressive strength 212 may be expressed in Pascal. The desired setting time 213 may be an initial setting time indicative of the time between placing the fresh AAC mixture and the moment when the AAC mixture starts losing its plasticity, i.e. when the mixture starts to solidify. Alternatively or complementary, the desired setting time 213 may be a final setting time indicative of the time between placing the AAC mixture and the moment when the AAC mixture is solidified, i.e. when trying to modify it's shape may negatively affect its strength development. The desired setting time 213 may be expressed in a unit of time, e.g. minutes or hours. The set of desired physical properties 211, 212, 213 may be obtained during a first step 201, e.g. based on a desired application of the AAC.

In addition to the set of desired physical properties 211, 212, 213, a dry bulk volume V_{b} 234 per unit volume of AAC may be obtained or provided. The dry bulk volume V_{b} 234 is a portion of a unit volume of AAC, e.g. a portion of one cubic meter of AAC, that includes the one or more coarse aggregates and the fine aggregate. In other words, the dry bulk volume V_{b} 234 may be a volume that is substantially filled with the aggregates to produce a unit volume of AAC. The dry bulk volume V_{b} 234 may be determined based on characteristics of the used aggregates. The dry bulk volume V_{b} 234 may for example be determined according to a predetermined relationship between the dry bulk volume 234, a maximum particle size of the coarse aggregates, and a mean particle size of the fine aggregate according to the ACI 211.1-91 standard.

In step 202, the mix proportion of the AAP mixture is determined from the set of desired physical properties 211, 212, 213 of the AAC based on a predetermined relationship 210 between the set of desired physical properties 211, 212, 213 and the mix proportion of the AAP mixture. The mix proportion of the AAP mixture is indicative of the ratio of constituents in the mixture in terms of weight, e.g. the ratio of the one or more precursors and the one or more chemical compounds. Thus, the predetermined relationship relates compressive strength, workability, and setting time to the ratio of constituents in the AAP mixture in terms of weight. The predetermined relationship 210 may, for example be expressed as a multi-dimensional look-up table that relates physical properties such as setting time, workability, and compressive strength 214; to ratios of constituents 215, 216, 217 in the AAP mixture.

The AAP mixture may be characterized by a limited set of such constituent ratios. This limited set of ratios may include a weight ratio of water to the first and second precursor w/b 221, a weight ratio of the first precursor to the first and second precursor p₁/b 222, a weight ratio of the first chemical compound to the first and second precursor cc₁/b 223, and a weight ratio of the second chemical compound to the first chemical compound cc₂/cc₁ 224. The first and second precursor may collectively be referred to as the binder b. Weight ratio w/b 221 may be indicative of the pores that are introduced in the mixture; weight ratio p₁/b 222 may be indicative of the reaction capacity of the precursors, weight ratio cc₁/b 223 may be indicative of the intensity of the alkali-activated reaction; and weight ratio cc₂/cc₁ 224 may be indicative of the compactness of the structure.

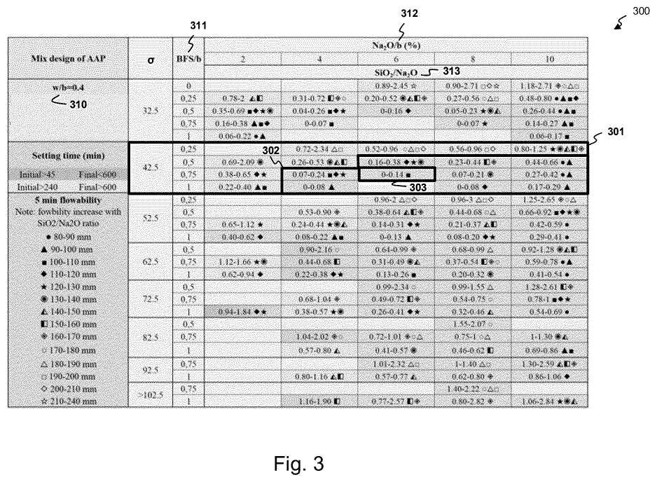

Thus, predetermined relationship 210 allows determining the mix proportion of the AAP mixture, i.e. weight ratios 221, 222, 223, 224, such that the AAC may achieve the desired physical properties 211, 212, 213 when combined with the aggregates. The mix proportion of the AAP mixture can be determined relatively fast, as it can directly be obtained from the predetermined relationship 210. The mix proportion of the AAP mixture can further be determined accurately, as the predetermined relationship expresses the interrelated variation in all the physical properties within the set of desired physical properties when the mix proportion changes. This has the further advantage that propagation of errors are avoided which can occur when determining mix proportions of AAC in a step-wise manner for the respective desired physical properties, e.g. when first determining a mix proportion or part of a mix proportion based on a desired compressive strength followed by determining a mix proportion or part of a mix proportion based on a desired workability and/or setting time. For example, look-up table 210 illustrates the relationship between compressive strength 214, weight ratio p₁/b 222, weight ratio cc₁/b 223, and weight ratio cc₂/cc₁ 224 for a certain setting time t_{d}213, a certain workability S_{d} 211, and a certain weight ratio w/b 221. It will be apparent that FIG. 2 merely illustrates an example of the multi-dimensional predetermined relationship with a limited number of dimensions. An example embodiment of the predetermined relationship with a larger number of dimensions is shown in FIG. 3.

Multi-dimensional look-up table 300 may be used to determine the mix proportion of an AAP mixture from a set of desired physical properties of the AAC that include, for example, a desired compressive strength of 40 MPa, a desired setting time between 45 min and 600 min, and a desired workability of 115 mm. First, potential AAP mix proportions 301 may be pre-selected from table 300 according to the desired compressive strength, i.e. 40 MPa. Second, the pre-selection of potential AAP mix proportions may be limited to 302 according to the desired setting time, i.e. between 45 min and 600 min. Finally, a mix proportion of the AAP mixture may be determined, i.e. 303, according to the desired workability, i.e. 115 mm. The determined mix proportion of the AAP mixture is thus characterized by a weight ratio w/b 310 of 0.4; a weight ratio p₁/b 311 of 0.75, a weight ratio cc₁/b 312 of 6%, and a weight ratio cc₂/cc₁ 313 of between 0 and 0.14. In other words, determining the mix proportion of the AAP mixture may comprise determining the respective weight ratios 310, 311, 312, 313.

Returning to FIG. 2, in the next step 203, the masses 261, 262 of the respective one or more coarse aggregates 231, 241 and the mass 263 of the fine aggregate 251 per unit volume 232 of AAC are determined. To this end, the particles of the respective aggregates 231, 241, 251 are packed within the dry bulk volume V_{b} 234 according to a particle packing model. Packing the particles refers to identifying a dense arrangement of particles within a predetermined volume, i.e. the dry bulk volume V_{b} 234, such that smaller particles may fill the voids created by larger particles. This allows determining the volume occupied by the respective aggregate particles 231, 241, 251 within the dry bulk volume V_{b} 234, thereby allowing to determine the masses 261, 262, 263 of the respective aggregates per unit volume of AAC. The particle packing model may be a binary packing model, e.g. a ‘Furnas’ model, a ‘Powers model’, or an ‘Aim and Goff’ model; a ternary packing model, e.g. a ‘Toufar’ model, or a ‘modified Toufar’ model; a multimodal packing model, e.g. a ‘Linear packing density’ model, LPDM, a modified LPDM, a solid suspension model, SSM, or a compressible packing model, CPM; or a continuous packing model, e.g. a ‘Fuller Thomson’ model, an ‘Andreassen’ model, or a ‘Rosin-Rammler’ model.

According to an example embodiment, the particle packing model may be a close-packing model based on close-packing theory. Herein, it may be assumed that aggregates with a smaller particle size fill the pores, i.e. voids, created by filling the dry bulk volume V_{b} 234 with an aggregate having a larger particle size. For example, in a first step 230, the dry bulk volume V_{b} 234 may be filled with the coarse aggregate 231 having the largest particle size. This creates voids 235 between the particles of the coarse aggregate 231. The coarse aggregate 231 may be characterized by a void ratio e_{ca1} indicative of the ratio of volume of voids to volume of solids. In a following step 240, the coarse aggregate 241 having a smaller particle size may be added to the dry bulk volume V_{b} 234, thereby substantially filling the voids 235 created by the largest coarse aggregate particles 231. This, in turn, creates voids between the particles of the coarse aggregates 231, 241. The coarse aggregate 241 with smaller particles may also be characterized by a void ratio e_{ca2} indicative of the ratio of volume of voids to volume of solids. In a following step 250, the fine aggregate 251 may be added to the dry bulk volume V_{b} 234, thereby substantially filling the remaining voids. In doing so, the volume occupied by the respective aggregates 231, 241, 251 within a unit volume of AAC may be determined. The respective masses 261, 262, 263 can then, for example, be determined as

$${m}_{ca 1} = {ρ}_{ca 1} \cdot ( 1 - {e}_{cal} ) \cdot {V}_{b} \qquad ( Eq . 1 )$$

$${m}_{c a 2} = {ρ}_{c a 2} \cdot ( 1 - {e}_{c a 2} ) \cdot {e}_{c a 1} \cdot {V}_{b} \qquad ( Eq . 2 )$$

$${m}_{f a} = β \cdot {ρ}_{f a} \cdot ( 1 - {e}_{c a 1} \cdot {e}_{c a 2} ) \cdot {V}_{b} \qquad ( Eq . 3 )$$

wherein m_{ca1}, m_{ca2}, and m_{fa} is the mass of the first coarse aggregate, the second coarse aggregate, and the fine aggregate, respectively; ρ_{ca1}, ρ_{ca2} and ρ_{fa} is the particle density of the first coarse aggregate, second coarse aggregate, and fine aggregate, respectively; e_{ca1} and e_{ca2} is the void ratio of the first and second coarse aggregate, respectively; V_{b} is the dry bulk volume; and β is the aggregate ratio. This allows determining the masses 261, 262, 263 of the respective aggregates per unit volume 232 of AAC regardless of the used aggregates, as the physical properties or characteristics of the used aggregates are considered when determining the mix proportion of the AAC mixture. In other words, the disclosed method is broadly applicable to a variety of aggregates, e.g. different sizes and/or types. It will be apparent that above steps 230, 240, 250 merely describe the concept of close-packing, and that the filling of the dry bulk volume with aggregates may not physically be performed to determine the mix proportion of the AAC mixture.

The aggregate ratio β may be indicative for a ratio of the volume of fine aggregate 251 to a combined volume of the one or more coarse aggregates 231, 241. The aggregate ratio β allows adjusting the workability of the AAC mixture as a higher quantity of fine aggregate 251, associated with an increased aggregate ratio, results in higher cohesion and lower slump value of the AAC mixture, and vice-versa. The aggregate ratio β may be determined based on a predetermined relationship between the aggregate ratio, the maximum particle size of coarse aggregates 231, 241, and a maximum particle size of the fine aggregate 251, e.g. according to the NBN EN 206 standard.

In a following step 204, the mass 264 of the AAP mixture per unit volume 232 of AAC to complete, i.e. fill, the remaining volume of the unit volume is determined. The remaining volume may thus be the unit volume reduced by the dry bulk volume, i.e. 233, and/or the volume of remaining voids between the particles of the aggregates 231, 241, 251 within the dry bulk volume. Determining the mass 264 of the AAP mixture may comprise determining the masses of the respective precursors, chemical compounds, and water included in the AAP mixture according to the determined weight ratios 221, 222, 223, 224. These masses can, for example, be determined by

$$\frac{{m}_{p 1}}{{m}_{p 1} + {m}_{p 2}} = \frac{{p}_{1}}{b} \qquad ( Eq . 4 )$$

$$\frac{{m}_{x 2} {C}_{c c 2}}{{m}_{p 1} + {m}_{p 2}} = \frac{c {c}_{1}}{b} \cdot \frac{c {c}_{2}}{c {c}_{1}} \qquad ( Eq . 5 )$$

$$\frac{M \cdot {m}_{x 1} + {m}_{x 2} \cdot {C}_{c c 1}}{{m}_{p 1} + {m}_{p 2}} = \frac{c {c}_{1}}{b} \qquad ( Eq . 6 )$$

$$\frac{( 1 - M ) \cdot {m}_{x 1} + {m}_{x 2} \cdot {C}_{w} + {m}_{w}}{{m}_{p 1} + {m}_{p 2}} = \frac{w}{b} \qquad ( Eq . 7 )$$

$$\frac{{m}_{ca 1}}{{ρ}_{ca 1}} + \frac{{m}_{ca 2}}{{ρ}_{ca 2}} + \frac{{m}_{fa}}{{ρ}_{fa}} + \frac{{m}_{p 1}}{{ρ}_{p 1}} + \frac{{m}_{p 2}}{{ρ}_{p 2}} + \frac{{m}_{x 1}}{{ρ}_{c 1}} + \frac{{m}_{x 2}}{{ρ}_{c 1}} + \frac{{m}_{w}}{{ρ}_{w}} = 1 \qquad ( Eq . 8 )$$

wherein x1 and x2 are the respective raw products used to generate the alkali activator, e.g. sodium hydroxide pearls and sodium silicate solution; mₓ₁ and mₓ₂ are the masses of these respective raw products; C_{cc1}, C_{cc2}, and C_{w} are the concentrations of chemical compound cc₁, cc₂, and water w in the alkali activator; M is the molar mass of the portion of raw product x1 that forms chemical compound cc₁; and (1−M) is the molar mass of the portion of raw product x1 that forms water.

In doing so, the masses 261, 262, 263, 264 of the respective constituents of the AAC mixture are determined per unit volume 232 of AAC for a set of desired physical properties 211, 212, 213 of the AAC, i.e. for a desired application. This allows determining the mix proportion of an AAC mixture in a cost-efficient manner, i.e. with limited trial and error. This has the advantage that the time and labour to determine or design an AAC mixture can be reduced; as the curing, testing, and screening of multiple empirical mixing proportions can be avoided. It is a further advantage that the method can easily be incorporated into existing production methods of conventional concrete. It is a further advantage that this can improve the utilization of AAC as a more ecological alternative to traditional concrete.

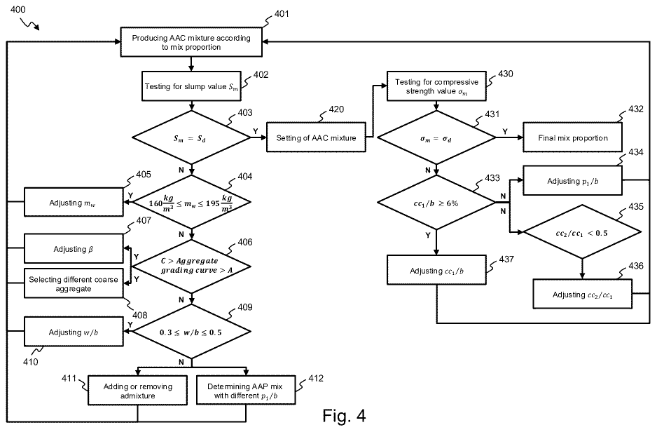

FIG. 4 shows additional steps 400 of the method for determining a mix proportion of an AAC mixture according to embodiments. Steps 400 may, for example, be performed after steps 200. In a first step 401, an AAC mixture may be produced according to the determined mix proportion during steps 200. Producing the AAC mixture may comprise combining and mixing the one or more coarse aggregates, the fine aggregate, the AAP mixture according to the determined mix proportion of the AAP. In other words, producing the AAC mixture may comprise combining the constituents of the AAC mixture according to the determined masses for the respective constituents per unit volume of AAC.

In a following step 402, a fresh sample of the produced AAC mixture may be tested to obtain a slump value. The slump value may be indicative of the workability of the AAC mixture. The slump value may be obtained by performing a typical slump test, wherein a freshly produced AAC mixture is poured into a slump cone and the height difference is measured before and after removing the slump cone. Alternatively, the slump value may be obtained by a flow table test, a K-slump test, a British compacting factor test, a Vebe consistometer test, or by means of an automated slump meter.

Next, the obtained slump value may be compared to the desired workability in step 403 to determine whether the AAC mixture meets the workability requirements for the desired application, i.e. 211 in FIG. 2. If not, the determined mix proportion may be adjusted according to a predetermined relationship between the mix proportion of the AAC mixture and the slump value in steps 404-412, such that the slump value of the adjusted AAC mixture meets the desired workability. Hereafter, the adjusted AAC mixture may be produced again in step 401 and tested in step 402 to verify if the desired workability is obtained.

This allows adjusting the determined mix proportion in a quantitative and controlled manner which predicts the effect of changing the mix proportion on the workability of the AAC. This further allows producing and testing a limited number of AAC mix proportions, as the change in the workability of the AAC can be estimated in advance. This has the advantage that an AAC mixture that meets the desired physical properties can be determined in a cost-efficient and time-efficient manner. It is a further advantage that the predetermined relationships between the mix proportion of the AAC mixture and the workability of the AAC are valid for most AAC mix proportions with engineering potential, i.e. mix proportions which may be considered for practical applications.

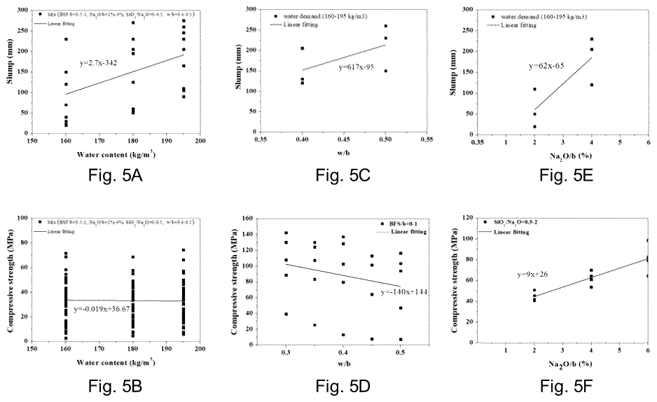

If the mass of water in the AAC mixture falls within a lower and upper threshold, e.g. between 160 kg/m³ and 195 kg/m³, the mass of water in the AAC mixture may be adjusted in step 405. This adjusting may be performed according to a predetermined positive linear relationship between the mass of water per unit volume of AAC and the slump value of the AAC mixture. FIG. 5A shows an example embodiment of this predetermined positive linear relationship for an AAC mixture with an AAP mixture wherein the first chemical compound is sodium oxide, Na₂O, the second chemical compound is silica, SiO₂, the first precursor is BFS, and the second precursor is FA. The slope of the predetermined positive linear relationship may be characterized by a change of at least about 1.8 mm and at most about 3.6 mm in the slump value of the AAC mixture for a change of about 1 kg/m³ in the mass of water per unit volume of AAC, preferably by a change of about 2.7 mm in the slump value of the AAC mixture for a change of about 1 kg/m³ in the mass of water per unit volume of AAC. Adjusting the mass of water in the AAC mixture may have a limited effect on the compressive strength of the AAC, as illustrated in FIG. 5B.

If the mass of water falls outside the lower and upper threshold in step 404, the method may continue to step 406. If the aggregate grading curve of the AAC mixture is lower than a lower threshold or higher than an upper threshold, e.g. grade ‘C’ and grade ‘A’ according to the NBN EN 206 standard respectively, the aggregate ratio β may be adjusted in step 407. For example, the slump value of the AAC mixture may be increased by decreasing the aggregate ratio, or vice-versa. Alternatively or complementary, a different coarse aggregate may be selected in step 408 that is characterized by a different maximum particle size and/or different shaped particles. For example, the slump value may be increased by increasing the maximum particle size of the aggregates and/or using an aggregate with substantially spherical particles.

If the aggregate grading curve of the AAC mixture is outside the boundaries of step 406, the method may continue to step 409. If the weight ratio of water to binder, i.e. the combined mass of precursors in the AAP mixture, w/b is between a lower and an upper threshold, e.g. 0.3 and 0.5 respectively, the weight ratio w/b may be adjusted in step 410. This adjusting may be performed according to a predetermined positive linear relationship between weight ratio w/b in the AAP mixture and the slump value of the AAC mixture. FIG. 5C shows an example embodiment of this predetermined positive linear relationship for an AAC mixture with an AAP mixture wherein the first chemical compound is sodium oxide, Na₂O, the second chemical compound is silica, SiO₂, the first precursor is BFS, and the second precursor is FA. The slope of the predetermined positive linear relationship may be characterized by a change of at least about 1 mm and at most about 11 mm in the slump value of the AAC mixture for a change of about 0.01 in the weight ratio w/b, preferably by a change of about 6 mm in the slump value of the AAC mixture for a change of about 0.01 in the weight ratio w/b. In addition to changing the slump value, adjusting the weight ratio w/b may also change the compressive strength value by at least about 0.5 MPa and at most about 1.1 MPa for a change of about 0.01 in the weight ratio w/b, preferably by around 0.8 MPa for a change of about 0.01 in the weight ratio w/b. FIG. 5D shows an example embodiment of a predetermined relationship between the weight ratio w/b and the 90-d compressive strength of an AAC mixture with an AAP mixture wherein the first chemical compound is sodium oxide, Na₂O, the second chemical compound is silica, SiO₂, the first precursor is BFS, and the second precursor is FA.

If the weight ratio w/b falls outside the boundaries in step 409, the mix proportion of the AAC mixture may be adjusted by adding or removing an admixture in step 411, i.e. reducing or increasing an amount of an admixture in the AAC mixture. The admixtures may, for example, be air entrainers, water reducers, set retarders, set accelerators, superplasticizers, reactivity inhibitors, or any other admixture known to the skilled person. Alternatively or complementary, a different mix proportion for the AAP mixture may be determined in step 412 that is characterized by a different weight ratio p₁/b, e.g. by reselecting an AAP mix proportion from table 300 in FIG. 3.

If the slump value obtained in step 402 meets the desired workability in step 403, a sample of the AAC mixture may be solidified in step 420, i.e. allowing the setting or hardening of the AAC mixture. The setting time may be between around 1 day and around 90 days, preferably the setting time may be around 7 days. Hereafter, the set and hardened AAC mixture may be tested to obtain a compressive strength value in step 430. The compressive strength value may, for example, be obtained by breaking an AAC sample in a compression-testing machine. The compressive strength value obtained in step 430 may further be extrapolated to a terminal compressive strength value to compare it to the desired compressive strength, i.e. when testing a sample after a limited time. For example, a 90-day terminal compressive strength value can be extrapolated based on a 7-day compressive strength value obtained by testing 430. This further improves the cost-efficiency and time-efficiency as a compressive strength test may be performed sooner. It is an advantage that the slump value can be tested and adjusted to meet the desired workability in steps 402-412 before testing the compressive strength, as this can avoid futile delays due to setting of the AAC mixture. Alternatively, the compressive strength value may be tested in step 430 even if the slump value deviates from the desired workability.

If the obtained compressive strength value meets the desired compressive strength for a desired application, i.e. 212 in FIG. 2, the final mix proportion 432 may be determined. If not, the determined mix proportion of the AAC mixture may be adjusted according to a predetermined relationship between the mix proportion of the AAC mixture and the compressive strength value in steps 433-437, such that the compressive strength of the adjusted AAC mixture meets the desired compressive strength. Hereafter, the adjusted AAC mixture may be produced again in step 401 and tested in step 402 to verify if the desired compressive strength is obtained.

This allows adjusting the determined mix proportion in a quantitative and controlled manner which predicts the effect of changing the mix proportion on the compressive strength of the AAC. This further allows producing and testing a limited number of AAC mix proportions, as the change in the compressive strength of the AAC can be estimated in advance. This has the advantage that an AAC mixture that meets the desired physical properties can be determined in a cost-efficient and time-efficient manner. It is a further advantage that the predetermined relationships between the mix proportion of the AAC mixture and the compressive strength of the AAC are valid for most AAC mix proportions with engineering potential, i.e. mix proportions which may be considered for practical applications.

If the weight ratio of the first chemical compound to the binder, i.e. cc₁/b, exceeds or equals a threshold, the mix proportion of the AAC mixture may be adjusted by adjusting the weight ratio cc₁/b in step 437. The threshold may, for example, be a ratio of about 6%. This adjusting may be performed according to a predetermined positive linear relationship between the weight ratio cc₁/b and the compressive strength value of the AAC mixture. FIG. 5F shows an example embodiment of this predetermined positive linear relationship for an AAC mixture with an AAP mixture wherein the first chemical compound is sodium oxide, Na₂O, the second chemical compound is silica, SiO₂, the first precursor is BFS, and the second precursor is FA. The slope of the predetermined positive linear relationship may be characterized by a change of at least about 3.2 MPa and at most about 6.8 MPa in the compressive strength value of the AAC mixture for about a 1% change in the weight ratio cc₁/b, preferably by a change of about 5 MPa in the compressive strength value of the AAC mixture for about a 1% change in the weight ratio cc₁/b. In addition to changing the compressive strength value, adjusting the weight ratio cc₁/b may also change the slump value by at least about 48 mm and at most about 76 mm for a change of about 1% in the weight ratio cc₁/b, preferably by around 62 mm for a change of about 1% in the weight ratio cc₁/b. FIG. 5E shows an example embodiment of this predetermined relationship between the weight ratio cc₁/b and the slump value of the AAC for an AAC mixture with an AAP mixture wherein the first chemical compound is sodium oxide, Na₂O, the second chemical compound is silica, SiO₂, the first precursor is BFS, and the second precursor is FA.

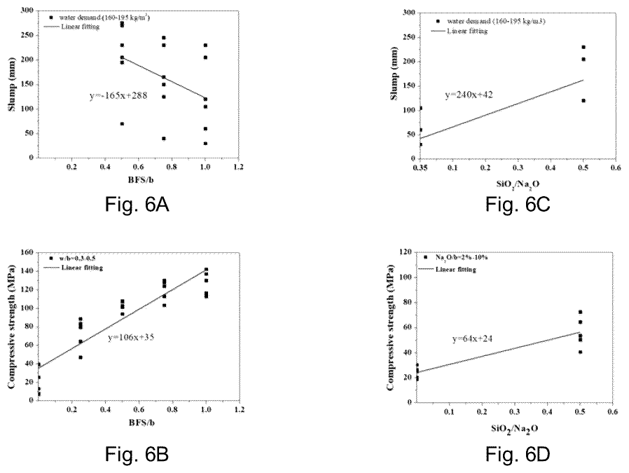

If the weight ratio of the weight ratio cc₁/b is lower than the threshold, the mix proportion may be adjusted by adjusting weight ratio p₁/b in step 434. This adjusting may be performed according to a predetermined positive linear relationship between the weight ratio p₁/b and the compressive strength value of the AAC mixture. FIG. 6B shows an example embodiment of this predetermined positive linear relationship for an AAC mixture with an AAP mixture wherein the first chemical compound is sodium oxide, Na₂O, the second chemical compound is silica, SiO₂, the first precursor is BFS, and the second precursor is FA. The slope of the predetermined positive linear relationship may be characterized by a change of at least about 5.5 MPa and at most about 6.5 MPa in the compressive strength value of the AAC mixture for a change of about 0.1 in the weight ratio p₁/b, preferably by a change of about 6 MPa in the compressive strength value of the AAC mixture for a change of about 0.1 in the weight ratio p₁/b. In addition to changing the compressive strength value, adjusting the weight ratio p₁/b may also change the slump value by at least about 9 mm and at most about 25 mm for a change of about 0.1 in the weight ratio p₁/b, preferably by around 17 mm for a change of about 0.1 in the weight ratio p₁/b. FIG. 6A shows an example embodiment of this predetermined relationship between the weight ratio p₁/b and the slump value of the AAC for an AAC mixture with an AAP mixture wherein the first chemical compound is sodium oxide, Na₂O, the second chemical compound is silica, SiO₂, the first precursor is BFS, and the second precursor is FA.

Alternatively or complementary, if the weight ratio of the second chemical compound to the first chemical compound in the alkali activator, i.e. cc₂/cc₁, is below a threshold, the mix proportion may be adjusted by adjusting weight ratio cc₂/cc₁ in step 436. The threshold may, for example, be a ratio of about 0.5. This adjusting may be performed according to a predetermined positive linear relationship between the weight ratio cc₂/cc₁ and the compressive strength value of the AAC mixture. FIG. 6D shows an example embodiment of this predetermined positive linear relationship for an AAC mixture with an AAP mixture wherein the first chemical compound is sodium oxide, Na₂O, the second chemical compound is silica, SiO₂, the first precursor is BFS, and the second precursor is FA. The slope of the predetermined positive linear relationship may be characterized by a change of at least about 2.2 MPa and at most about 5.8 MPa in the compressive strength value of the AAC mixture for a change of about 0.1 in the weight ratio cc₂/cc₁, preferably by a change of about 4 MPa in the compressive strength value of the AAC mixture for a change of about 0.1 in the weight ratio cc₂/cc₁. In addition to changing the compressive strength value, adjusting the weight ratio cc₂/cc₁ may also change the slump value by at least about 18 mm and at most about 30 mm for a change of about 0.1 in the weight ratio cc₂/cc₁, preferably by around 24 mm for a change of about 0.1 in the weight ratio cc₂/cc₁. FIG. 6C shows an example embodiment of this predetermined relationship between the weight ratio cc₂/cc₁ and the slump value of the AAC for an AAC mixture with an AAP mixture wherein the first chemical compound is sodium oxide, Na₂O, the second chemical compound is silica, SiO₂, the first precursor is BFS, and the second precursor is FA.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A method for determining a mix proportion of an alkali activated concrete, AAC, mixture for a set of desired physical properties of the AAC, and for a dry bulk volume of one or more coarse aggregates and a fine aggregate per unit volume of AAC; wherein the desired physical properties include a desired workability, a desired compressive strength, and a desired setting time of the AAC; wherein the AAC mixture comprises one or more precursors, an alkali activator comprising one or more chemical compounds, the one or more coarse aggregates, the fine aggregate, and water; the method comprising:
determining a mix proportion of an alkali activated paste, AAP, mixture from the set of desired physical properties of the AAC based on a predetermined relationship between the set of desired physical properties of the AAC and the mix proportion of the AAP mixture; wherein the AAP mixture comprises the one or more precursors, the one or more chemical compounds of the alkali activator, and water according to the determined mix proportion of the AAP;
determining masses of the respective one or more coarse aggregates per unit volume of AAC and a mass of the fine aggregate per unit volume of AAC by packing particles of the respective aggregates within the dry bulk volume according to a particle packing model; and
determining a mass of the AAP mixture per unit volume of AAC to complete a remaining volume within the unit volume.

2. The method according to claim 1, wherein determining masses of the respective one or more coarse aggregates per unit volume of AAC is further based on particle densities of the respective one or more coarse aggregates, and void ratios of the respective one or more coarse aggregates.

3. The method according to claim 2, wherein determining a mass of the fine aggregate per unit volume of AAC is further based on a particle density of the fine aggregate, the void ratios of the respective one or more coarse aggregates, and an aggregate ratio; wherein the aggregate ratio is indicative for a ratio of the volume of fine aggregate to a combined volume of the one or more coarse aggregates.

4. The method according to claim 1, wherein the alkali activator comprises an aqueous solution of a first chemical compound and a second chemical compound; and wherein the AAP mixture comprises a first precursor, a second precursor, and the alkali activator.

5. The method according to claim 4, wherein the AAP mixture is has a weight ratio of water to the first and second precursor, a weight ratio of the first precursor to the first and second precursor, a weight ratio of the first chemical compound to the first and second precursor, and a weight ratio of the second chemical compound to the first chemical compound; and wherein determining the mix proportion of the AAP mixture further comprises determining the respective weight ratios.

6. The method according to claim 5, wherein determining a mass of the AAP mixture per unit volume of AAC further comprises determining a mass of the respective precursors, a mass of the respective chemical compounds of the alkali activator, and a mass of water based on the weight ratios.

7. The method according to claim 1, further comprising:
producing the AAC mixture according to the determined mix proportion of the AAC mixture;
testing a fresh sample of the AAC mixture to obtain a slump value and/or testing a hardened sample of the AAC mixture to obtain a compressive strength value; and
adjusting the determined mix proportion of the AAC mixture if the slump value and/or the compressive strength value deviate from the desired physical properties of the AAC.

8. The method according to claim 7, wherein adjusting the determined mix proportion of the AAC mixture further comprises adjusting the determined mix proportion according to a predetermined relationship between the mix proportion of the AAC mixture and the slump value.

9. The method according to claim 8, wherein adjusting the determined mix proportion comprises adjusting the mass of water per unit volume of AAC according to a predetermined positive linear relationship between the mass of water per unit volume of AAC and the slump value of the AAC mixture.

10. The method according to claim 5, wherein adjusting the determined mix proportion comprises adjusting the weight ratio of water to the first and second precursor in the AAP mixture according to a predetermined positive linear relationship between the weight ratio of water to the first and second precursor in the AAP mixture and the slump value of the AAC mixture.

11. The method according to claim 5, wherein adjusting the determined mix proportion comprises at least one of:
adjusting a ratio of the volume of fine aggregate to a combined volume of the one or more coarse aggregates to adjust the cohesion and water retention of the AAC mixture;
selecting at least one different coarse aggregate having a different maximum particle size and/or different shaped particles;
adding or removing an amount of admixture; and
determining a mix proportion of an AAP mixture from the desired physical properties with a different weight ratio of the first precursor to the first and second precursor.

12. The method according to claim 7, wherein adjusting the determined mix proportion of the AAC mixture further comprises adjusting the determined mix proportion according to a predetermined relationship between the mix proportion of the AAC mixture and the compressive strength value.

13. The method according to claim 5, wherein adjusting the determined mix proportion comprises adjusting the weight ratio of the first precursor to the first and second precursor according to a predetermined positive linear relationship between the weight ratio of the first precursor to the first and second precursor, and the compressive strength value of the AAC mixture.

14. The method according to claim 5, wherein adjusting the determined mix proportion comprises, if the weight ratio of the second chemical compound to the first chemical compound is lower than a threshold, adjusting the weight ratio of the second chemical compound to the first chemical compound according to a predetermined positive linear relationship between the weight ratio of the second chemical compound to the first chemical compound, and the compressive strength value of the AAC mixture.

15. The method according to claim 5, wherein adjusting the determined mix proportion comprises, if the weight ratio of the first chemical compound to the first and second precursor exceeds a threshold, adjusting the weight ratio of the first chemical compound to the first and second precursor according to a predetermined positive linear relationship between the weight ratio of the first chemical compound to the first and second precursor, and the compressive strength value of the AAC mixture.

16. The method according to claim 8, wherein adjusting the determined mix proportion comprises adjusting the weight ratio of water to the first and second precursor in the AAP mixture according to a predetermined positive linear relationship between the weight ratio of water to the first and second precursor in the AAP mixture and the slump value of the AAC mixture.

17. The method according to claim 8, wherein adjusting the determined mix proportion comprises at least one of:
adjusting a ratio of the volume of fine aggregate to a combined volume of the one or more coarse aggregates to adjust the cohesion and water retention of the AAC mixture;
selecting at least one different coarse aggregate having a different maximum particle size and/or different shaped particles;
adding or removing an amount of admixture; and
determining a mix proportion of an AAP mixture from the desired physical properties with a different weight ratio of the first precursor to the first and second precursor.

18. The method according to claim 12, wherein adjusting the determined mix proportion comprises adjusting the weight ratio of the first precursor to the first and second precursor according to a predetermined positive linear relationship between the weight ratio of the first precursor to the first and second precursor, and the compressive strength value of the AAC mixture.

19. The method according to claim 12, wherein adjusting the determined mix proportion comprises, if the weight ratio of the second chemical compound to the first chemical compound is lower than a threshold, adjusting the weight ratio of the second chemical compound to the first chemical compound according to a predetermined positive linear relationship between the weight ratio of the second chemical compound to the first chemical compound, and the compressive strength value of the AAC mixture.

20. The method according to claim 12, wherein adjusting the determined mix proportion comprises, if the weight ratio of the first chemical compound to the first and second precursor exceeds a threshold, adjusting the weight ratio of the first chemical compound to the first and second precursor according to a predetermined positive linear relationship between the weight ratio of the first chemical compound to the first and second precursor, and the compressive strength value of the AAC mixture.
